(19) United States
(12) Patent Application Publication
(10) Pub. No.: US 2015/0014209 A1
(43) Pub. Date: Jan. 15, 2015

(54) SEASON EAZE

(71) Applicant: Lloyd Lamont Fairgood, Fort Wayne, IN (US)

(72) Inventor: Lloyd Lamont Fairgood, Fort Wayne, IN (US)

(21) Appl. No.: 13/937,663

(22) Filed: Jul. 9, 2013

(51) Int. Cl. A47J 45/00

(52) U.S. Cl. CPC A47J 45/00
USPC 206/541

(57) ABSTRACT

Season-Eaze is a container with a compartment on top for holding a pair of tongs when seasoning or flowing raw meat and other foods.

Season-Eaze allows people to rest their tongs in a safe, sanitary place after use, preventing the spread of germs and diseases. This innovative product may comprise a rectangular container, made of plastic or other suitable material, with a hinged lid. The hinge can be located on the back of the box which also, allowing the lid to open up from the front. Inside the container can be a removable plastic or metal grill to separate the seasoning or flour from the food during preparation. The smaller unit can be used for salads, vegetables and more. The smaller unit also turns into a lunch box that is dishwasher and microwave safe. Affixed to the top of this container can be a smaller box-like container with open snap lid with a 360-degree turn that's attach to the container with screw and nut volt for comfort of seasoning, when applied, a pair of small- to medium-sized tongs can slide into the back of the box allowing people to rest their tongs in a safe, sanitary place after use, preventing the spread of germs and diseases. Affixed to the top of this container can be a smaller box-like container can also be used for condiments as well when used for lunch box uses. The containers also can be used for meat marinating or any other foods. The containers also have a drain point with a cap or any other material to stop leakage or liquid. the containers has a hole for on bottom corner which can be place anywhere on the container for draining or to stop leakage or liquid The container can be offered in any sizes to accommodate all users. The larger container can measure approximately 12″ in length, 7″ in width, and 3″ in height, whereas the smaller container can measure approximately 8.5″ in length, 5.5″ in width, and 2″ in height. The container on the top to house the tongs can measure approximately 3.5″ in length, 2″ in width, and 1.5″ in height. The exact specifications may vary upon manufacturing. The container is also used for Seasoning and flouring meats and other foods can be highly messy and can spread germs, as people have to touch the food, seasoning, and flour with their hands. Some seasonings can even get trapped underneath people's fingernails. To avoid this, many people use a pair of tongs to handle meats and foods. Although convenient, a pair of tongs can also spread germs and bacteria if people set down the used tongs on a clean surface.

### BRIEF DESCRIPTION OF DRAWINGS

the brief description is as followed:

FIG. 1 shows the design and the appearance of the product Season Eaze

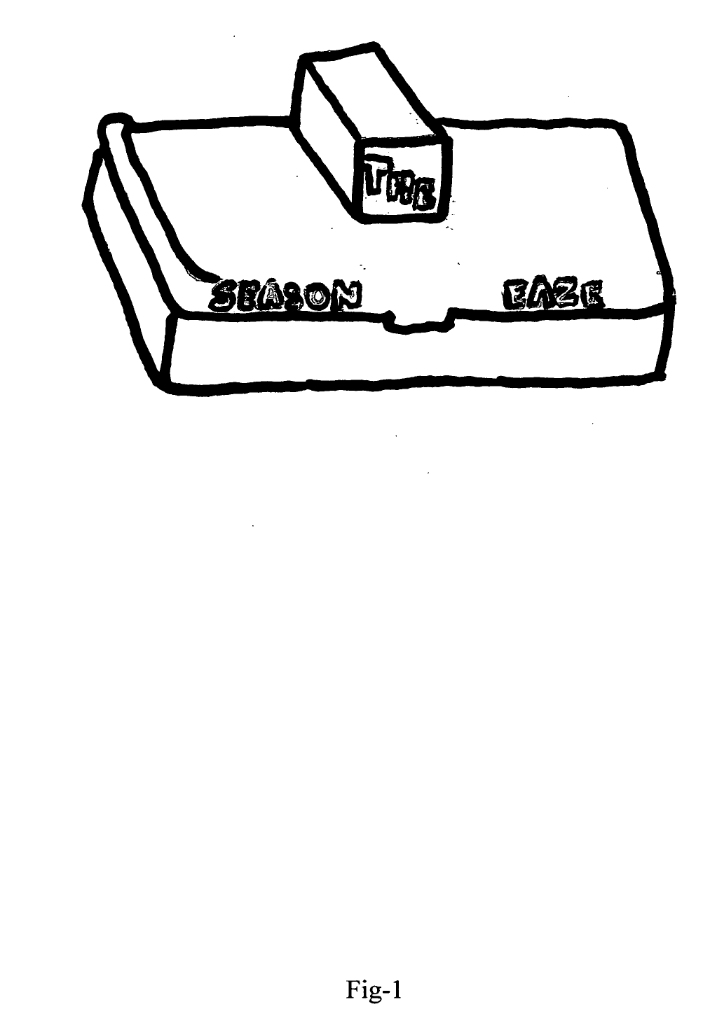

FIG. 2 shows an open view of the inside and how it looks and how its built.

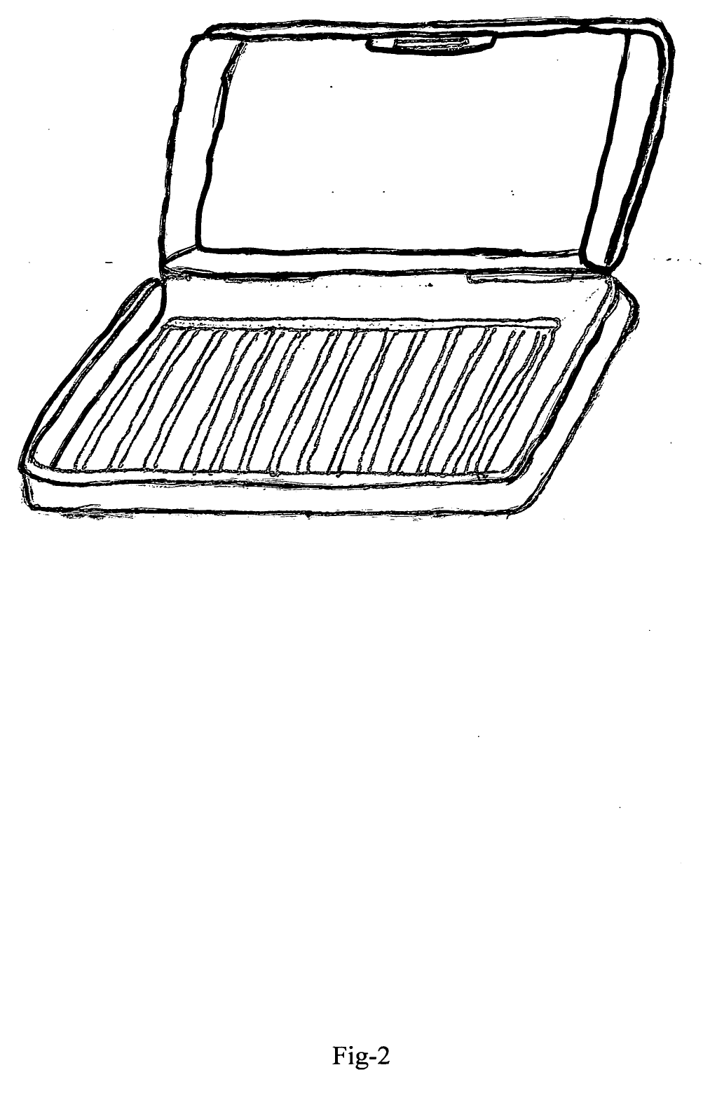

FIG. 3 shows the side of the Season Eaze how it would look and how it would be seen if in uses and also it shows a drain point for liquids.

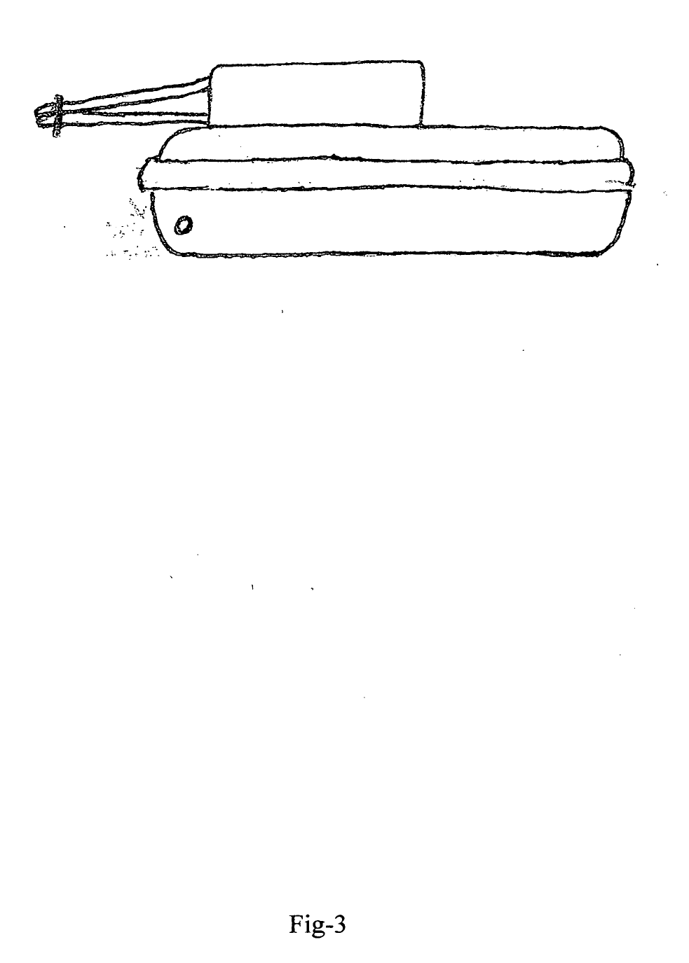

FIG. 4 shows the back of the Season Eaze and how its design looks and fit for operation.

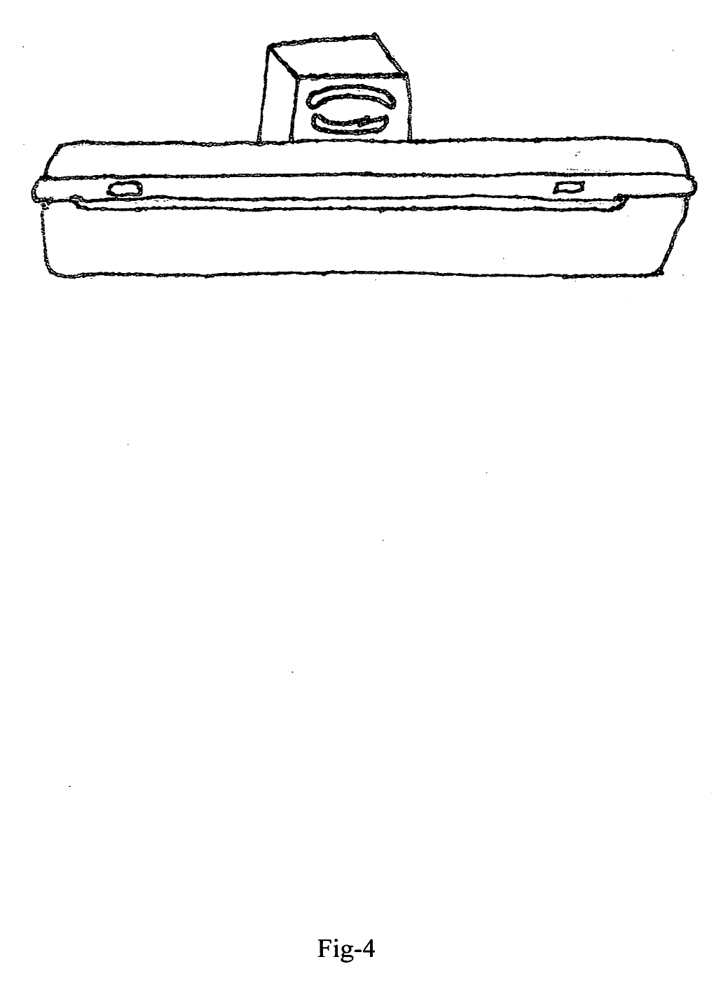

FIG. 5 show the top compartment of the Season Eaze which is used for both tongs and condiments.

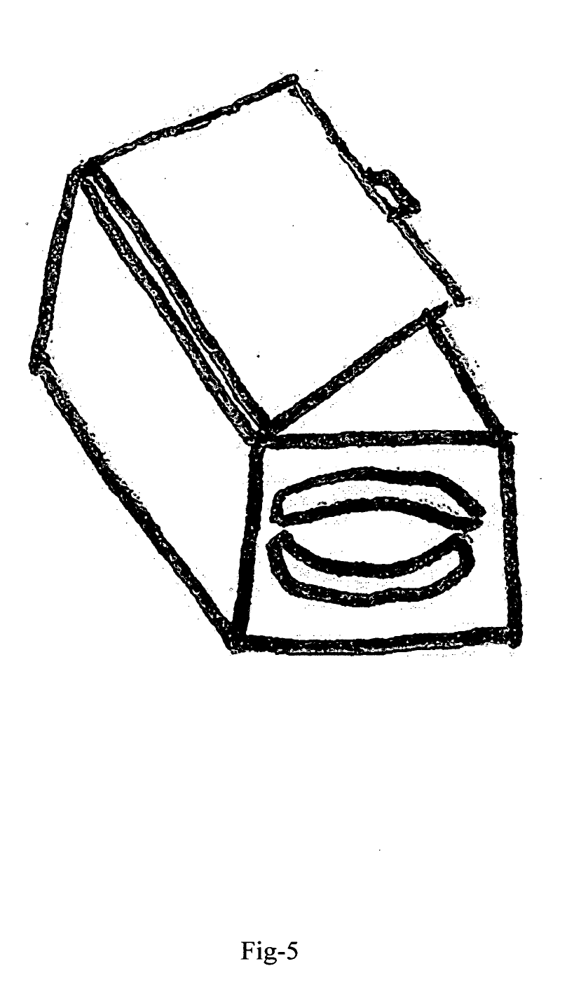

What is claimed:

1. Provides people with a sanitary way to season or flour meat and other foods. Eliminates the need to touch raw meat by hand. Acts as a storage compartment for condiments or a lunchbox as well. Prevents people from setting used tongs on a clean surface or countertop. Is ideal for at-home cooks, line cooks, and professional chefs. Top compartment acts as self-place for tongs to slides in and out the back of the top compartment box for uses of seasoning or any that's similar the season ease. Both the large and small containers can be used with a variety of seasonings or vegetables. Shows how the tongs can be placed inside the small containers on the top. The containers also can be used for meat marinating or any other foods. The containers also have a drain point with a cap or any other material to stop leakage or liquid. The containers has a hole for on bottom corner which can be place anywhere on the container for draining or to stop leakage or liquid
